(19) United States
(12) Patent Application Publication
(10) Pub. No.: US 2021/0025195 A1
(43) Pub. Date: Jan. 28, 2021

(54) ELECTRONIC DEVICE FOR OPENING AND/OR CLOSING A DOOR, COMPRISING AN ELECTRIC LOCK, AND METHOD FOR THE FITTING THEREOF

(71) Applicant: HAVR, Venette (FR)

(72) Inventors: Guillaume DUPREZ, Margny les Compiegne (FR); Alexandre BALLET, Nay (FR); Simon LAURENT, Agny (FR)

(73) Assignee: HaVr, Venette (FR)

(21) Appl. No.: 16/645,071

(22) PCT Filed: Sep. 11, 2018
(86) PCT No.: PCT/FR2018/052213

§ 371 Date: Mar. 6, 2020

(30) Foreign Application Priority Data
Sep. 14, 2017 (FR) 17 58530

(51) Int. Cl. E05B 47/06; E05B 47/00

(52) U.S. Cl. CPC E05B 47/0615; E05B 47/0012; E05Y 2900/132; E05B 2047/0084; E05B 2047/002; E05B 2047/0094

(57) ABSTRACT

The invention relates to an electronic device (1) configured for opening/closing a door (P) or similar, from a light signal defining an opening and/or closing code emitted by a movable transmitter having means for emitting said light signal,
said electronic device having an electric lock comprising:
   a lock cylinder (2) with a stator (20) and a rotor (21), as well as an electric actuator (3) configure to modify the state of the electric lock,
   means for receiving signals configured to detect light pulses comprising a receiving diode (4),
   a control unit (5) connected to the receiving diode (4) and connected to the electric actuator (3), configured to decode the light pulses detected by said receiving means and to determine a control of the electric actuator (3).

According to the invention, the diode (4) is advantageously protected and all of the means (3, 4, 5) are self-supporting with the lock cylinder (2) in order to facilitate the installation of it as a conventional lock cylinder.

The present invention relates to an electronic device for opening and/or closing a door, or similar, comprising an electric lock, as well as a method for installing such an electric lock on a door or similar.

The field of the invention is that of electric locks: this type of lock comprises an electric actuator to change the state of the lock, namely from a closing state to an opening state, this actuator being controlled by the electronics of a control unit itself connected to means for receiving a signal coming from a transmitter.

The invention is more specifically focused on electronic devices, of which the opening or closing of the door by the electric lock is controlled from a light signal in the visible area, of which the light pulses define an opening and/or closing code.

This opening/closing code is emitted by a movable transmitter having means for emitting said light signal. The movable transmitter can be a smartphone on which a suitable piece of software is downloaded. The means for emitting the light signal can be the flash from the telephone.

Such a state of the art is, for example, disclosed by the device from document WO2016/124544 A1 which comprises:
a lock cylinder which is coupled to an electric actuator referenced 13 such as a motor for changing the state of the lock,
receiving means referenced 16, comprising a photodiode referenced 20, suitable for detecting pulses from the light signal,
a control unit referenced 17, connected to said receiving means and connected to the actuator 13, comprising electronics configured to decode the light pulses from the signal detected by said receiving means and for determining a control of the actuator 13 to change the state of the electric lock.

Such an electric lock is advantageous in that it makes it possible to use the smartphone of the users as a control member, after downloading the dedicated application. The use of a control signal in the form of light pulses also makes it possible to offer a high security level, thanks to the use of the flash of the telephone. The light flow of the flash being substantially directive, it is thus more difficult to hack into, compared with wi-fi or Bluetooth® signals, which radiating, can be easily listened to: the hacking risks are reduced.

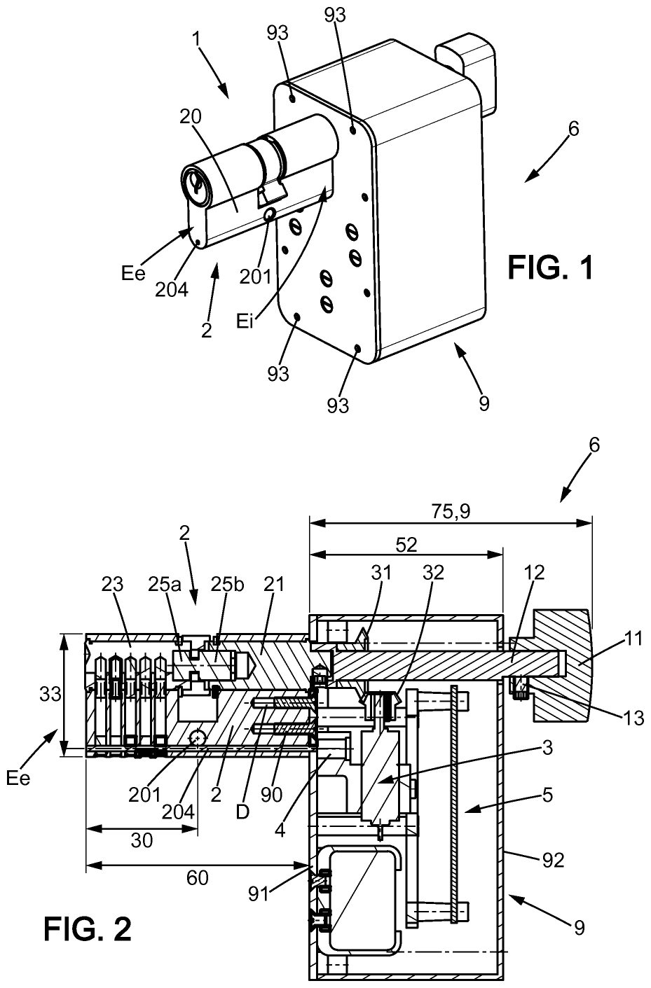

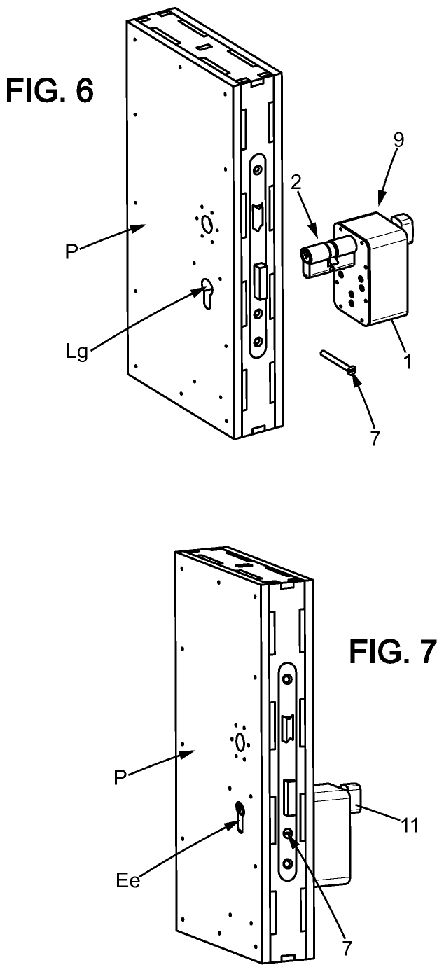

On the contrary, and according to the observations of the inventors, the use of a light flow as a control signal makes it compulsory to provide receiving means 16, and in particular the photodiode of the outer side of the door, namely on the same side form which the light signal is emitted, and as illustrated in FIG. 1 of document WO2016/124544 A1, or also to provide the integration of this photodiode in a case, received in the door, this case making it possible to receive the smartphone form an access opening of the outer side of the door. This case thus has an opening for the passage of the light signal to the detecting photodiode, referenced 220, and as illustrated according to the embodiment of FIGS. 5 and 6 of document WO2016/124544 A1.

In both cases, whether the embodiment of FIG. 1, or that of FIGS. 5 and 6, the means for receiving the light signal require, for the integration thereof, a specific and dedicated housing in the door, i.e. a housing separate from the housings already present in the door for the integration of the handle and of the lock cylinder, in particular.

The embodiment of FIG. 1 with photodiode easily accessible from the outer side of the door can also be easily damaged by an act of vandalism, making the electric lock inoperable.

The aim of the present invention is to overcome the disadvantages mentioned by proposing an electronic device configured to open/close a door or similar, from the light signal defining an opening and/or closing code emitted by a movable transmitter having means for emitting said light signal and of which the electric lock is of simplified installation with respect to the abovementioned state of the art, and while limiting the abovementioned risks of vandalism.

Advantageously, and as will be understandable below:
the installation of the electronic device according to the invention will not require, in terms of installation steps, any additional step compared with those necessary for the mounting of a conventional lock cylinder known by a person skilled in the art as a European cylinder, namely that the fixing of such a European-type cylinder, just requires the insertion of the lock cylinder in a housing passing through the door or suitable shape for a European profile cylinder, then the implementation of a fixing screw from the edge of the door, this screw engaging with a threading of the stator of the lock cylinder to ensure the locking in position of the lock cylinder in the housing thereof,
the receiving diode of the electronic lock and being used to detect the pulses from the light signal will be inaccessible and thus protected from acts of malice.

Other aims and advantages of the present invention will appear during the following description which is only given for information and which does not aim to limit it.

Also, the invention first relates to an electronic device configured to open/close a door or similar, from a light signal defining an opening and/or closing code emitted by a movable transmitter having means for emitting said light signal,

said electronic device having an electric lock comprising:
a lock cylinder with a stator and a rotor, as well as an electric actuator configured to modify the state of the electric lock, from an opening state to a closing state, or vice versa,
means for receiving signals configured to detect the light pulses in the visible area comprising a receiving diode,
a control unit connected to the receiving diode and connected to the electric actuator, configured to decode the light pulses detected by said receiving means and determine a control of the electric actuator to change the state of the lock.

According to the invention:
the lock cylinder, the means for receiving signals and the control unit form a self-supporting assembly, the device being configured so as to make it possible to mount the self-supporting assembly to the door by inserting the lock cylinder in a door housing intended for a lock cylinder, then implementation of a fixing screw engaging with a threaded bore of the stator from the edge of the door,
said lock cylinder comprises said stator and said rotor rotated by the electric actuator, as well as a lock pin actuated in rotation by the rotor, intended to control a locking latch, the stator having two longitudinal ends, with a so-called outer end which, when the lock cylinder is housed in said housing of the door, is intended to be positioned on the side of the door from which the light signal is emitted to control the opening or the closing of the electric lock, called outer side of the door, and an inner end of the stator which is intended to be positioned on the opposite side of the door of that from which the light signal is emitted to control the opening or the closing of the electric lock, called inner side of the door,
said receiving diode belonging to said receiving means is positioned at a distance from the outer end of the stator of the lock cylinder to the inner end, said receiving diode being, in particular, in the self-supporting assembly and so as to be inaccessible.

In addition and according to a first possibility, the stator comprises a closed cross-sectional channel opening to the outer end of the stator, said channel being configured to enable the transmission of the light signal emitted from the outer side of the door to said receiving diode, arranged internal and inaccessible.

Alternatively, and according to a second possibility, the stator comprises an open channel or a level configured to as to form a closed cross-sectional channel only once the lock cylinder in mounted in a housing of the door for a European profile lock cylinder, said channel formed being configured to enable the transmission of the light signal emitted from the outer side of the door to said receiving diode (4), arranged internal and inaccessible.

According to optional features of the invention, taken individually or in combination:
the channel formed by the stator is a closed cross-sectional channel or alternatively, the stator having a level or an open cross-sectional channel configured so as to form a closed cross-sectional channel only once the lock cylinder is mounted in the housing of the door (P) for a European profile lock cylinder;
an optical fibre is configured to ensure the guiding of the light signal from the outer end of the stator and to the diode internal to said self-supporting assembly arranged internal to the channel of the stator according to the first possibility, or in the channel formed between the housing for a European profile cylinder and the stator according to the second possibility;
said self-supporting assembly comprises a case integral with the stator of the lock cylinder protruding from the lower end of the stator, the case receiving said control unit;
the case is fixed to the inner end of the stator of the lock cylinder by way of screws engaging with threaded bores of the stator;
the case internally receives the receiving diode of the receiving means. Said channel passing through the stator of the lock cylinder of the longitudinal end called outer end to the other longitudinal end, called inner end;
the case internally receives the electric actuator;
the case receives an electric energy source (such as battery or cells) for the electric supply of the control unit (5) and of the electric actuator;
the electric actuator comprises an electric motor, of axis of rotation substantially perpendicular to the axis of rotation of the rotor of the lock cylinder, as well as a meshing forming a bevel gear, comprising a first conic pinion integral with the rotor, and a second conic pinion integral with the output of the electric motor;
the electric lock comprises a manual control comprising a gripping portion, intended to be actuatable from the inner side of the stator, and a shaft integral with the rotor, the manual control being configured so as to make it possible to change the state of the lock by a manual rotation action on the gripping portion;
the rotor actuated by said electric actuator is called first rotor, the lock cylinder comprises a second rotor, provided internal to the stator, independent from the first rotor, said second rotor having a recess forming a keypath for receiving a key, the second rotor being configured so as to make it possible to change the state of the lock by rotating the key inserted in the keypath of the second rotor from the outer end of the stator, a coupling mechanism being configured to ensure the coupling of the second rotor to the lock pin only when the key is inserted in the keypath of the second rotor;
the second rotor and stator assembly forms a pin tumbler lock;
the receiving diode is configured to detect the light pulses and to emit a visual light signal which can be seen from the outer end of the stator, and wherein following the detection of a light signal defining an opening and/or closing code, and generation by the control unit of a control for closing or for closing, the control unit is configured to control the diode in order to emit a visual signal showing a success of the opening or closing operation.

The invention also relates to an installation method comprising the following steps:
providing a self-supporting assembly of an electric lock of an electronic device according to the invention,
inserting the lock cylinder of the self-supporting assembly in a door housing intended to receive a lock cylinder, from the side of the door opposite that from which the light signal is intended to be emitted to control the opening or the closing of the electric lock,
locking the self-supporting assembly by inserting the fixing screw from the edge of the door of the fixing screw in the threaded bore of the stator of the lock cylinder.

The invention be better understood upon reading the following description accompanied by the appended figures among which:

FIG. 1 is a perspective view of an electric lock of an electronic device according to the invention, the lock cylinder, the means for receiving signals and the control unit advantageously form a self-supporting assembly, and according to an embodiment for which the lock cylinder, of European profile, can be controlled not only by the actuator, but also by a flat key,

FIG. 2 is a cross-sectional view of the electric lock of FIG. 1, along a vertical plane passing through the lock cylinder, illustrating more specifically the positioning of the diode removed from said outer end of the stator of the lock cylinder, and the presence of a channel making it possible to transmit the light signal along the stator, to the diode received inside a protruding case and integral with the inner end of the stator of the lock cylinder,

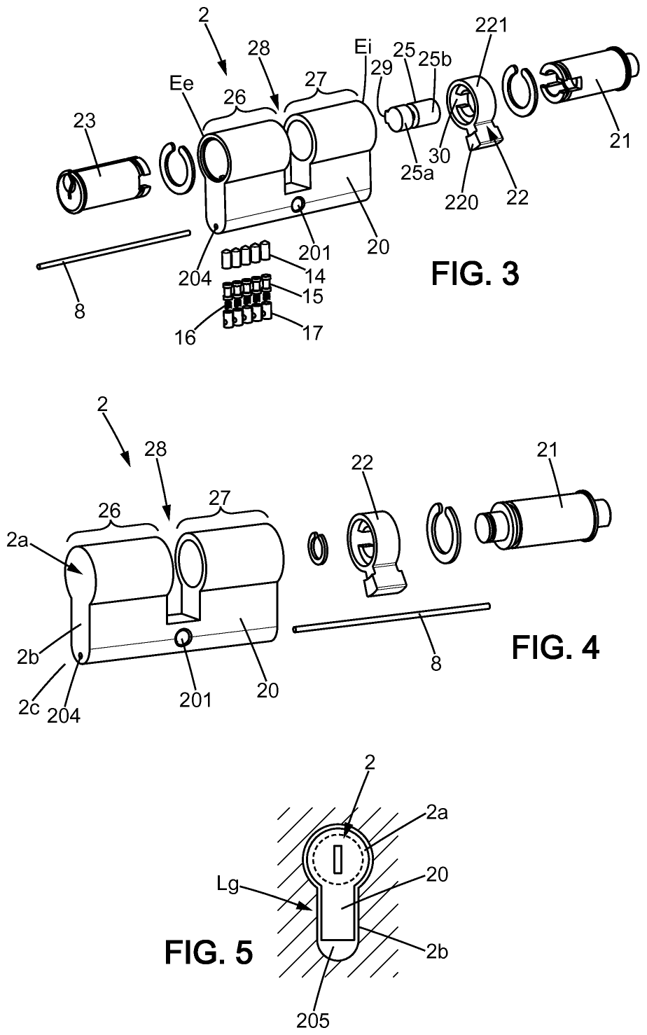

FIG. 3 is an exploded view of the lock cylinder of the device of FIG. 1, illustrating more specifically the stator, the first motorised rotor and a second rotor with a cavity for a keypath, the lock pin which is actuatable by the first rotor or the second rotor, the coupling/decoupling mechanism making it possible to couple the second rotor to the lock pin only during the insertion of a key; and the active pins and passive pins of the pin tumbler lock formed by the stator assembly/second rotor, as well as an optical fibre intended to extend into the channel of the stator,

FIG. 4 is an exploded view of the lock cylinder with a single rotor which can replace that of FIG. 3, illustrating more specifically the stator, the motorised rotor and the lock pin which is actuatable by the rotor, and an optical fibre intended to extend into the channel of the stator, said lock cylinder having no key mechanism,

FIG. 5 is a schematic view illustrating a second embodiment for which the channel enabling the transmission of the light signal is formed between a level or similar at the base of the stator and a housing for European profile lock cylinder,

FIGS. 6 and 7 illustrate two mounting steps making it possible to install the self-supporting assembly to a door, namely inserting the lock cylinder of the self-supporting assembly in a door housing from the side of the door opposite that from which the light signal is intended to be emitted to control the opening or the closing of the electric lock, then locking the self-supporting assembly by inserting the fixing screw from the edge of the door and screwing the fixing screw in the threaded bore of the stator of the lock cylinder.

Also, the invention relates to an electronic device 1 configured to open/close a door P or similar, from a light signal defining an opening and/or closing code emitted by a moveable transmitter having means for emitting said light signal.

For this purpose, the electronic device has an electric lock comprising:
a lock cylinder 2 with a stator 20 and a rotor 21, as well as an electric actuator 3 configured to modify the state of the electric lock, from an opening state to a closing state, or vice versa,
means for receiving signals configured to detect light pulses in the visible area comprising a receiving diode 4,
a control unit 5 connected to the receiving diode 4 and connected to the electric actuator 4, configured to decode the light pulses detected by said receiving means and to determine a control of the electric actuator 3 to change the state of the lock.

Notably, and according to the invention, the lock cylinder 2, the means for receiving signals and the control unit 5 form a self-supporting assembly 6, the device being configured so as to make it possible to mount the self-supporting assembly 6 to the door by inserting the lock cylinder 2 in a housing Lg of door P intended for a European profile lock cylinder (see FIG. 6), then implementing a fixing screw 7 engaging with a threaded bore 201 of the stator 20 from the edge of the door (see FIG. 7).

The installation of the electronic device 1 according to the invention is therefore extremely simple and does not require in terms of steps, any additional step to those required for the mounting of a conventional lock cylinder, of European profile.

The lock cylinder 2 comprises said stator 20 and said rotor 21 rotated by the electric actuator 3, as well as a lock pin 22 actuated in rotation by the rotor 21, intended to controlling a locking latch. The stator 20 has two longitudinal ends, with a so-called outer end Ee which, when the lock cylinder 20 is housed in said housing Lg of the door, is intended to be positioned on the side of the door from which the light signal is emitted to control the opening or the closing of the electric lock. Thus, the outer side of the door is referred to. The stator 20 also comprises an inner end Ei of the stator 20 which is intended to be positioned on the side opposite the door P of that from which the light signal is emitted to control the opening or the closing of the electric lock; thus, the inner side of the door is referred to.

Notably, said receiving diode 4 belonging to said receiving means is advantageously positioned at a distance from the outer end Ee of the stator of the lock cylinder 2 to the inner end Ei, said receiving diode 4 inaccessible at least when said self-supporting assembly is mounted to the door, in particular internal to the self-supporting assembly. The resistance of the electronic device against the risks of malice is improved in this, in that it is not possible to easily damage this diode from the outer side of the door.

According to a first possibility of the invention illustrated as a non-limiting example in FIG. 2, the stator 20 comprises a closed cross-sectional channel 204 opening at the outer end Ee of the stator 20, said channel 204 being configured to enable the transmission of the light signal emitted from the outer side of the door to said receiving diode 4, arranged internal and inaccessible.

Alternatively, and according to a second possibility illustrated as a non-limiting example in FIG. 5, the stator 20 comprises an open channel or a level 24 configured so as to form a closed cross-sectional channel 205 only once the lock cylinder 2 is mounted in a housing Lg of the door P for a European profile lock cylinder. This channel thus formed is configured to enable the transmission of the light signal emitted from the outer side of the door to said receiving diode 4, arranged internal and inaccessible.

A European profile cylinder 2 comprises a stator with circular portion 2a coaxial to the rotor(s) of the cylinder, and an extended portion 2b extending radially projecting from the circular portion, and ended at the low portion thereof by an arched convex profile 2c.

As illustrated in FIG. 5, the base of the stator 20 can have a level, in particular at the base of the stator, over all or some of the length of the stator, and such that a closed cross-sectional channel 205 is created between an arched profile at the base of the housing for the European profile cylinder and the level: in FIG. 5, this level removes the abovementioned arched profile 2c, and in view of creating the channel 205.

According to the first embodiment possibility, it is noted that the closed cross-sectional channel can be achieved by a longitudinal bore, in particular over the whole length of the stator 2, made on the cross-section of the abovementioned arched profile stator 2c. It is also noted that this channel can be located below the threaded bore 201 configured for the fixing of the lock cylinder 2, this threaded bore 201 being conventionally, substantially orthogonal to the axis of the stator and to the radial direction of the extended portion 2b, made by removing material in the extended portion 2b.

According to an embodiment, an optical fibre 8 can be configured to ensure the guiding of the light signal from the outer end Ee of the stator 20 and to the diode 4 internal to said self-supporting assembly 6 arranged internal to the channel 204 of the stator according to the first possibility, or in the channel 205 formed between the housing for a European profile cylinder and the stator 2, according to the second possibility.

According to an embodiment, said self-supporting assembly 6 can comprise a case 9 integral with the stator 20 of the lock cylinder 2 protruding from the inner end Ei of the stator 20. This case 9 receives all or some of the following elements:
the control unit 5,
the receiving diode 4,
the electric actuator 3,
an electric energy source 10 such as a battery or cells for the electric supply.

The case 9 can be fixed to the inner end Ei of the cylinder stator by way of screws 90 engaging with threaded bores of the stator 20. The threaded bores are, for example, provided on the extended portion 2b, and as illustrated in FIG. 2. For example, the case comprises a fixing plate 91 and a (removable) cover 92 together forming a receiving interspace for the abovementioned elements. The plate 91 is, for example, born on the flat surface at the inner end Ei of the stator, the plate 91 being fixed to the stator 20 by the fixing screws 90.

The cover is a hollow element which can be fixed to the plate 91, by screws 93, passing through holes of the plate 91. Of course, other fixing modes can be considered between the plate and the case, such as a fixing by clips.

In the case where the case internally receives the receiving diode 4 of the receiving means, and according to the first possibility, said channel 204 passes through the stator 20 of the lock cylinder of the longitudinal end called outer end Ee to the other longitudinal end, called inner end Ei. In the case where the case internally receives the receiving diode 4 of the receiving means, and according to the second possibility, the level 24 extends over the whole length of the stator 20.

The electric actuator 3 can comprise an electric motor 30, and a meshing connecting the output of the electric motor with the rotor 21. This electric motor 30 causes the rotation of the rotor 21 and of the associated lock pin 22 when controlled along a direction of rotation to the opening, or along a direction of rotation to the closing.

As illustrated as an example in FIG. 2, this motor 3 can be of axis of rotation, substantially perpendicular to the axis of rotation of the rotor 21 of the lock cylinder 2. The meshing thus forms a bevel gear, and comprises a first conic pinion 31 integral with the rotor 21, and a second conic pinion 32 integral with the output of the electric motor 30.

The electric lock can also comprise a manual control comprising a gripping portion 11, intended to be actuatable on the inner side of the door P, and a shaft 12 integral with the rotor 21, extended from the rotor 21 to the outside of the stator, from the inner end of the stator 20. This manual control is configured to as to make it possible to change the state of the lock by a manual rotation action on the gripping portion 11.

In FIG. 2, it is noted that said shaft 12 is coaxial to the rotor 21, and passes through the case 9, on either side, emerging at the outside through the terminal end thereof. The gripping portion 11 is fixed to the terminal end of the shaft 12, for example via a clamping screw 13.

According to an embodiment illustrated as an example in FIGS. 1 to 3, the lock cylinder 2 comprises a second rotor making it possible to actuate with a key. Thus, the rotor 21 actuated by said electric actuator 3 being said first rotor, the lock cylinder 2 comprises a second rotor 23, provided internal to the stator 20. This second rotor 23 has a longitudinal recess forming a keypath and is configured so as to make it possible to change the state of the lock by rotating the key inserted in the second rotor 23, from the outer end of the stator. The second rotor 23 and stator 20 assembly can thus form a pin tumbler lock.

Such an embodiment is illustrated as a non-limiting example in FIG. 3: the stator 20 comprises, from the outer end Ee, a first cross-section of length 26 with circular portion comprising a bore intended to receive the second rotor 23, followed by a second cross-section of length 27 with circular portion comprising a bore intended to receive the second rotor 23. An intermediate indentation 28 between the first cross-section of length 26 and the second cross-section of length 27, receives the lock pin 22. This lock pin 22 comprises a driver 220 intended to engage, with the actuation mechanism, a latch of the door, as well as a ring 221, mounted coaxial to the rotors 21, 23.

A coupling mechanism 25 is configured to ensure the coupling of the second rotor 23 to the lock pin 22 only when the key is inserted in the keypath of the second rotor 23.

The coupling mechanism can comprise a pin device received through the ring 221 of the lock pin 22 and which comprises two shaft portions 25a and 25b, integral with one another by an axis pivot coaxial to the shafts 25a and 25b. The shaft portion 25a comprises a pin 29 integral with the rotation of the portion 25a to the second rotor 23 and the shaft portion 25b comprises a pin (which cannot be seen) integral with the shaft portion 25b to the first rotor 21.

This pin device with portions 25a, 25b is mounted sliding along a course limited through the ring 221 of the lock pin, constrained by a spring in the direction of the second rotor 23 in the absence of presence of a key.

In this position (absent key), only the pin of the portion 25b engages with a pin groove 30 of the lock pin 22, thus linking the rotation of the first rotor 21 to that of the lock pin 22: in particular and as illustrated in FIG. 2, the portion 25a is clear from the pin groove of the lock pin 22, thus coupling the rotation of the second rotor 23 and the rotation of the lock pin 22: it is thus possible to rotate the first rotor 21 and the lock pin 22, without rotating the second rotor 23.

When a key is inserted in the keypath of the second rotor, the end of the key comes into contact with the pin device 25a, 25b, driving the latter of a course limited in the direction of the lock pin 22, against the return force of the spring.

This movement causes the coupling of the second rotor 23 with the lock pin 22 by engagement of the pin 29 in the pin groove 30 of the lock pin 22: the rotation of the key thus makes it possible to rotate the second rotor 23 and the lock pin 22. Preferably, and in this position (key inserted), the first rotor 21 always remains coupled to the lock pin 22 (and to the second rotor 23): such an arrangement makes it possible for the electronics to detect an opening of the mechanism by key. For this purpose, an angular coder makes it possible to follow the rotation of the first rotor. According to this embodiment, the stator assembly 20, second rotor 23 can form a pin tumbler lock. As illustrated in FIG. 3, the second rotor 23 thus has radial bores for active pins 14, and the portion 2b of the stator 20 of the corresponding bores for passive pins 15, springs 16 pushing the pins 14, 15, bearing on the stoppers 17. In a known manner, the profile of the key makes it possible to ensure that the plane bears between the active pins 14 and the passive pins 15 is combined with the second rotor 23/stator interface, thus freeing up the rotation of the second rotor 23.

According to another embodiment illustrated in FIG. 4, the lock cylinder 2 comprises one single rotor, referenced 21 which can be moved by the electric actuator 3 by an electric control of the control unit 5, or also from the inside thanks to the manual control which comprises the shaft 12 and the gripping portion 11. However, and according to this embodiment, this lock cylinder does not have a second key-operating rotor. Thus, and such as illustrated in FIG. 4, the first cross-section of length 26 of the stator 20 can be solid, only the second cross-section of length 27 having a bore for the rotor 21.

Also notably, the diode 4 used can be a photodiode, used only in receiving, to detect the pulses. Advantageously, the receiving diode 4 can also be configured not only to detect the light pulses, but also to emit a visual light signal which can be seen from the outer end of the stator 20. Following the detection of a light signal defining an opening and/or closing code, and generation by the control unit 5 of a control to the closing or to the opening, the control unit can control the diode in order to emit a visual signal showing the success of the opening or closing operation, for example, green in colour.

Conversely, in case of non-recognition of the code of the light signal, the control unit can control the diode in order to emit a visual signal showing the failure of the operation, for example, red in colour.

The invention also relates to an installation method comprising the following steps:
providing a self-supporting assembly 6 of an electric lock of an electronic device according to the invention,
inserting the lock cylinder 2 of the self-supporting assembly 6 in a door P housing 6 intended to receive a lock cylinder, from the side of the door opposite that from which the light signal is intended to be emitted to control the opening or the closing of the electric lock,
locking the self-supporting assembly 6 by inserting the fixing screw from the edge of the door of the fixing screw in the threaded bore 201 of the stator 20 of the lock cylinder 2.

### NOMENCLATURE

1. Electronic device,
2. Lock cylinder,
2a. Circular portion of the stator of the European profile lock cylinder,
2b. Extended portion of the European profile lock cylinder extending radially from the circular portion,
2c. Arched profile ending the extended portion to the base of the stator of the European profile lock cylinder,
20. Stator,
201. Threaded bore (for fixing screw 7),
204. Channel formed by the stator,
205. Channel formed between a level of the stator and a door housing for European profile lock cylinder (FIG. 5),
21. Rotor (in particular, first rotor) controlled by the electric actuator,
22. Lock pin,
220. Driver (lock pin),
221. Ring (lock pin),
23. Second rotor (with keypath),
24. Level,
25. Coupling mechanism,
25a, 25b. Two shaft portions of a pin device (coupling mechanism),
26. First cross-section of length (stator),
27. Second cross-section of length (stator),
28. Indentation,
3. Electric actuator,
30. Electric motor,
31, 32. Conic pinions of the meshing forming a bevel gear,
4. Receiving diode such as photodiode,
5. Control unit,
6. Self-supporting assembly,
7. Fixing screw,
8. Optical fibre,
9. Case,
90. Fixing screw (fixing of the case to the stator),
91, 92. Respectively plate and hollow cover forming the case,
93. Fixing screw (cover 92 on plate 91),
10. Electric energy source,
11, 12. Gripping portion and shaft of the manual control,
13. Clamping screw,
14. Active pins,
15. Passive pins,
16. Springs (pins),
17. Stoppers,
Ee. Outer end (stator of the cylinder),
Ei. Inner end (stator of the cylinder),
P. Door,
Lg. Door housing for receiving the European profile lock cylinder.

1. An electronic device (1) configured for opening/closing a door (P) or similar, from a light signal defining an opening and/or closing code emitted by a movable transmitter having means for emitting said light signal,
said electronic device having an electric lock comprising:
a lock cylinder (2) with a stator (20) and a rotor (21), as well as an electric actuator (3) configured to modify the state of the electric lock, from an opening state to a closing state, or vice versa,
means for receiving signals configured to detect light pulses in the visible area comprising a receiving diode (4),
a control unit (5) connected to the receiving diode (4) and connected to the electric actuator (3), configured to decode the light pulses detected by said receiving means and to determine a control of the electric actuator (3) to change the state of the lock,
characterised in that the lock cylinder (2), the means for receiving signals and the control unit form a self-supporting assembly (6), the device being configured so as to make it possible to mount the self-supporting assembly (6) to the door by inserting the lock cylinder (2) in a door (P) housing (Lg) intended for a lock cylinder, then implementing a fixing screw (7) engaging with a threaded bore (201) of the stator (20) from the edge of the door,
and in that the lock cylinder (2) comprises said stator (20) and said rotor (21) rotated by the electric actuator (3), as well as a lock pin (22) actuated in rotation by the rotor (21), intended to control a locking latch, the stator (20) having two longitudinal ends, with a so-called outer end (Ee) which, when the lock cylinder (20) is housed in said housing (Lg) of the door, is intended to be positioned on the side of the door form which the light signal is emitted to control the opening or the closing of the electric lock, called outer side of the door, and an inner end (Ei) of the stator (20) which is intended to be positioned on the side opposite the door (P) of that from which the light signal is emitted to control the opening or the closing of the electric lock, called inner side of the door,
and in that said receiving diode (4) belonging to said receiving means is positioned at a distance from the outer end (Ee) of the stator of the lock cylinder (2) to the inner end (Ei), said receiving diode (4) being in the self-supporting assembly and so as to be inaccessible,
and in that:
according to a first possibility, the stator (20) comprises a closed cross-sectional channel (204) opening at the outer end (Ee) of the stator (20), said channel (204) being configured to enable the transmission of the light signal emitted from the outer side of the door to said receiving diode (4), arranged internal and inaccessible,
according to a second possibility, the stator (20) comprises an open channel or a level (24) configured so as to form a closed cross-sectional channel (205) only once the lock cylinder (2) is mounted in a housing (Lg) of the door (P) for a European profile lock cylinder, said channel formed being configured to enable the transmission of the light signal emitted from the outer side of the door to said receiving diode (4), arranged internal and inaccessible.

2. The electronic device according to claim 1, wherein the channel (204) formed by the stator (20) is a closed cross-sectional channel.

3. The electronic device according to claim 1, wherein the stator (20) having a level or an open cross-sectional channel configured so as to form a closed cross-sectional channel only once the lock cylinder is mounted in the housing (Lg) of the door (P) for a European profile lock cylinder.

4. The electronic device according to claim 1, wherein an optical fibre (8) is configured to ensure the guiding of the light signal from the outer end (Ee) of the stator (20) and to the diode (4) internal to said self-supporting assembly (6) arranged internal to the channel (204) of the stator according to the first possibility, or in the channel formed between the housing for a European profile cylinder and the stator (2) according to the second possibility.

5. The electronic device according to claim 1, wherein said self-supporting assembly (6) comprises a case (9) integral with the stator (20) of the lock cylinder (2) protruding from the inner end (Ei) of the stator, the case receiving said control unit (5).

6. The electronic device according to claim 5, wherein the case (9) is fixed to the inner end (Ei) of the stator (20) of the lock cylinder (2) by way of screws (90) engaging with threaded bores of the stator (20).

7. The electronic device according to claim 6, wherein the case internally receives the receiving diode (4) of the receiving means, said channel (204) passing through the stator (20) of the lock cylinder of the longitudinal end called outer end (Ee) to the other longitudinal end called inner end (Ei).

8. The electronic device according to claim 6, wherein the case (9) internally receives the electric actuator (3).

9. The electronic device according to claim 1, wherein the case (9) receives an electric energy source (10) for the electric supply of the control unit (5) and of the electric actuator.

10. The electronic device according to claim 1, wherein the electric actuator (3) comprises an electric motor (30), of axis of rotation substantially perpendicular to the axis of rotation of the rotor (21) of the lock cylinder (2), as well as a meshing forming a bevel gear, comprising a first conic pinion (31) integral with the rotor, and a second conic pinion (32), integral with the output of the electric motor (30).

11. The electronic device according to claim 10, comprising a manual control comprising a gripping portion (11), intended to be actuatable from the inner side of the door (P), and a shaft (12) integral with the rotor (21), extended from the rotor to the outside of the stator, from the inner end of the stator (20), the manual control being configured so as to make it possible to change the state of the lock by a manual rotation action on the gripping portion (11).

12. The electronic device according to claim 1, wherein the rotor (21) actuated by said electric actuator (3) is called first rotor, the lock cylinder (2) comprises a second rotor (23), provided internal to the stator (20), independent from the first rotor (21), said second rotor having a recess forming a keypath for receiving a key, the second rotor (23) being configured so as to make it possible to change the state of the lock by rotating the key inserted in the keypath of the second rotor (23) from the outer end of the stator, a coupling mechanism (25) being configured to ensure the coupling of the second rotor (23) to the lock pin (22) only when the key is inserted in the keypath of the second rotor (23).

13. The electronic device according to claim 12, wherein the second rotor (23) and stator (20) assembly forms a pin tumbler lock (14, 15).

14. The electronic device according to claim 1, wherein the receiving diode is configured to detect the light pulses and to emit a visual light signal which can be seen from the outer end of the stator (20), and wherein, following the detection of a light signal defining an opening and/or closing code, and generating by the control unit (5) a control of the actuator (3) to the closing or to the closing, the control unit (5) is configured to control the diode in order to emit a visual signal showing the success of the opening or closing operation.

15. An installation method, comprising the steps of:
providing a self-supporting assembly of an electric lock of an electronic device according to one of claims 1 to 14,
inserting the lock cylinder (2) of the self-supporting assembly (6) in a door (P) housing (Lg) intended for receiving a lock cylinder, from the side of the door opposite that from which the light signal is intended to be emitted to control the opening or the closing of the electric lock, and
locking of the self-supporting assembly (6) by inserting the fixing screw (7) from the edge of the door and screwing the fixing screw in the threaded bore (201) of the stator (20) of the lock cylinder (2).
